(19) United States
(12) Patent Application Publication
(10) Pub. No.: US 2026/0089619 A1
(43) Pub. Date: Mar. 26, 2026

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Haorui YANG, Dongguan (CN)

(21) Appl. No.: 19/404,169

(22) Filed: Dec. 1, 2025

Related U.S. Application Data
(63) Continuation of application No. PCT/CN2023/111489, filed on Aug. 7, 2023.

(51) Int. Cl. H04W 48/18; H04W 60/04; H04W 84/04

(52) U.S. Cl. CPC H04W 48/18; H04W 60/04; H04W 84/042

(57) ABSTRACT

A wireless communication method includes: receiving, by a terminal device, first information transmitted by a first network device and used for selecting a network, where the first information is associated with a first public land mobile network (PLMN) and a second PLMN, and a network selection mode supported by the first PLMN is different from a network selection mode supported by the second PLMN.

### CROSS-REFERENCE TO RELATED APPLICATION

This application is a Continuation Application of International Application No. PCT/CN2023/111489 filed Aug. 7, 2023, which is incorporated herein by reference in its entirety.

### TECHNICAL FIELD

The present disclosure relates to the technical field of communication, and more particularly, to a wireless communication method, a terminal device and a network device.

### BACKGROUND

Currently, communication systems support multiple network selection modes. Pieces of information corresponding to different network selection modes and used for selecting network devices are independent of each other. As a result, when a terminal device performs network selection, the terminal device usually first performs network selection based on information corresponding to one network selection mode, and then performs network selection based on information corresponding to another network selection mode. This network selection mode is not flexible enough.

### SUMMARY

The present disclosure provides wireless communication methods, a terminal device, and a network device. Various aspects involved in the present disclosure will be introduced below.

In a first aspect, a wireless communication method is provided, which includes: receiving, by a terminal device, first information transmitted by a first network device and used for selecting a network. The first information is associated with a first public land mobile network (PLMN) and a second PLMN, and a network selection mode supported by the first PLMN is different from a network selection mode supported by the second PLMN.

In a second aspect, a terminal device is provided, which includes: a transceiver, a memory and a processor, where the memory is configured to store a computer program, and the computer program, when executed by the processor, enables the terminal device to perform: receiving first information transmitted by a first network device and used for selecting a network. The first information is associated with a first public land mobile network (PLMN) and a second PLMN, and a network selection mode supported by the first PLMN is different from a network selection mode supported by the second PLMN.

In a third aspect, a first network device is provided, which includes: a transceiver, a memory and a processor, where the memory is configured to store a computer program, and the computer program, when executed by the processor, enables the first network device to perform: receiving or transmitting first information used for selecting a network. The first information is associated with a first PLMN and a second PLMN, and a network selection mode supported by the first PLMN is different from a network selection mode supported by the second PLMN.

### BRIEF DESCRIPTION OF THE DRAWINGS

FIG. 1 is a wireless communication system 100 to which embodiments of the present disclosure are applied.

FIG. 2 is a schematic diagram of an international mobile subscriber identity (IMSI) applicable to embodiments of the present disclosure.

FIG. 3 is a schematic diagram of a wireless communication method according to an embodiment of the present disclosure.

FIG. 4 is a schematic flowchart of a wireless communication method according to another embodiment of the present disclosure.

FIG. 5 is a schematic flowchart of a wireless communication method according to yet another embodiment of the present disclosure.

FIG. 6 is a schematic flowchart of a wireless communication method according to yet another embodiment of the present disclosure.

FIG. 7 is a schematic flowchart of a wireless communication method according to yet another embodiment of the present disclosure.

FIG. 8 is a schematic diagram of a terminal device according to an embodiment of the present disclosure.

FIG. 9 is a schematic diagram of a network device according to an embodiment of the present disclosure.

FIG. 10 is a schematic diagram of a network device according to another embodiment of the present disclosure.

FIG. 11 is a schematic structural diagram of a communication apparatus according to an embodiment of the present disclosure.

### DETAILED DESCRIPTION

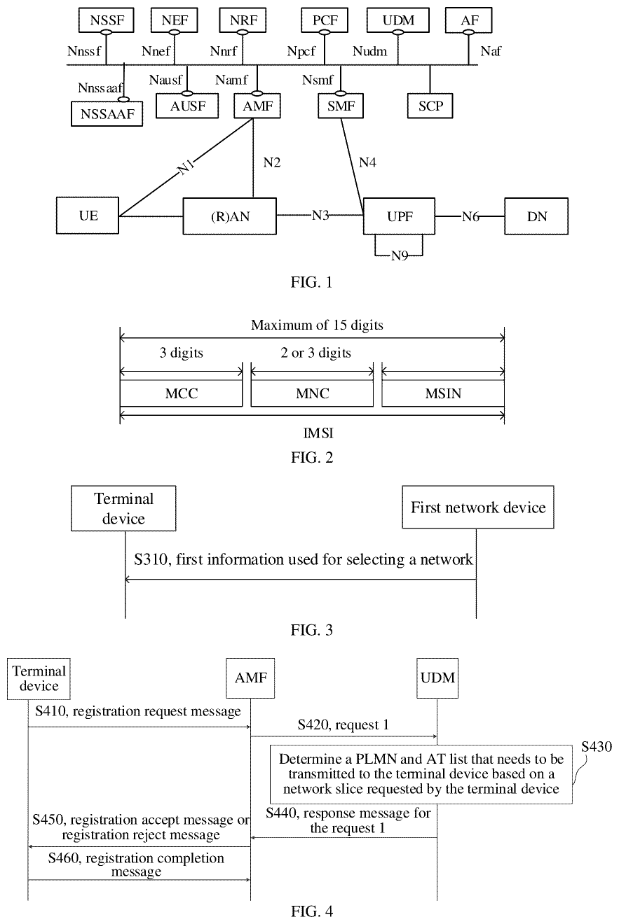

Technical solutions in the present disclosure will be described below with reference to drawings. To facilitate understanding, a schematic diagram of a communication system architecture in embodiments of the present disclosure will be introduced below with reference to FIG. 1. FIG. 1 is a schematic diagram of a communication system architecture applicable to the embodiments of the present disclosure. The network architecture may include a terminal device, an access network (AN) element, and a core network element.

It should be understood that the technical solutions of the embodiments of the present disclosure may be applied to various communication systems, such as a 5th generation (5G) system, a new radio (NR), a long term evolution (LTE) system, an LTE frequency division duplex (FDD) system, an LTE time division duplex (TDD). The technical solutions provided in the present disclosure may further be applied to future communication systems, such as a 6th generation mobile communication system, a satellite communication system.

The terminal device in the embodiments of the present disclosure may also be referred to as a user equipment (UE), an access terminal, a user unit, a user station, a mobile station, a mobile station (MS), a mobile terminal (MT), a remote station, a remote terminal, a mobile device, a user terminal, a terminal, a wireless core network element, a user agent or a user apparatus. The terminal device in the embodiments of the present disclosure may be a device that provides voice and/or data connectivity for users and may be used for connecting people, objects and machines, such as a handheld device or in-vehicle device with wireless connection functions. The terminal device in the embodiments of the present disclosure may be a mobile phone, a pad, a laptop computer, a palm computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, or the like. Optionally, the UE may be configured to act as a base station. For example, the UE may act as a scheduling entity that provides sidelink signals between UEs in vehicle-to-everything (V2X) or device-to-device (D2D) scenarios. For example, cell phones and cars communicate with each other using sidelink signals. The cellular phones and the smart home devices communicate with each other, without the communication signal being relayed through the base station.

The access network element may be an access network device. The access network device may be an access device that enables the terminal to wirelessly access the network architecture, and is mainly responsible for wireless resource management, quality of service (QoS) management, data compression and encryption on the air interface side. The access network device may also be referred to as a radio access network (RAN) device. For example, the access network device may be a base station. The base station may broadly cover various names as follows, or be replaced with following names, such as: node B (NodeB), evolved NodeB (eNB), next generation NodeB (gNB), relay station, access point, transmitting and receiving point (TRP), transmitting point (TP), master eNB (MeNB), secondary eNB (SeNB), multi-standard radio (MSR) node, home base station, network controller, access node, wireless node, access point (AP), transmission node, transceiver node, base band unit (BBU), remote radio unit (RRU), active antenna unit (AAU), remote radio head (RRH), central unit (CU), distributed unit (DU), positioning node. The base station may be a macro base station, a micro base station, a relay node, a donor node, or the like, or a combination thereof. The base station may further refer to a communication module, modem or chip that is designed to be provided within the above device or apparatus. The base station may further be a device that performs base station functions in a mobile switching center, D2D communication, V2X communication, or machine-to-machine (M2M) communication, a network side device in the 6th generation network, or a device that performs base station functions in the future communication system. The base station may support networks with the same or different access technologies (AT). The specific technology and specific device form adopted by the access network device will not be limited in the embodiments of the present disclosure.

The base station may be fixed or mobile. For example, a helicopter or a drone may be configured to act as a mobile base station. One or more cells may move based on the location of the mobile base station. In some other examples, a helicopter or a drone may be configured to function as a device communicating with another base station.

In some deployments, the access network device in the embodiments of the present disclosure may refer to a CU or a DU, or the access network device includes a CU and a DU. The gNB may further include an AAU.

The types of core network elements may include a user plane function (UPF) network element, an access and mobility management function (AMF) network element, a session management function (SMF) network element, a policy control function (PCF) network element, an application function (AF) network element, a data network (DN) network element, a network slice selection function (NSSF) network element, an authentication server function (AUSF) network element, a unified data management function (UDM) network element, a network exposure function (NEF) network element, a network repository function (NRF), and a network slice-specific authentication and authorization function (NSSAAF) network element. The UPF network element is mainly responsible for the transmission of user data, and other network elements may be referred to as control plane function network elements, which are mainly responsible for authentication, authorization, registration management, session management, mobility management and policy control, etc., to ensure reliable and stable transmission of the user data.

The UPF network element may be used for forwarding and receiving terminal data. For example, the UPF network element may receive service data from the data network and transmit it to the terminal through the access network device. The UPF network element may further receive user data from the terminal through the access network device and forward it to the data network. Transmission resources allocated and scheduled by the UPF network element to the terminal are managed and controlled by the SMF network element. A bearer between the terminal and the UPF network element may include: user plane connection between the UPF network element and the access network device, and establishment of a channel between the access network device and the terminal. The user plane connection is a QoS flow that may be established between the UPF network element and the access network device for transmitting data.

The AMF network element may be used to manage terminal access to the core network, such as terminal location update, network registration, access control, terminal mobility management, terminal attachment and detachment. The AMF network element may further provide storage resources for a control plane of a session of the terminal in a case of providing services for the session, to store a session identifier, an SMF network element identifier associated with the session identifier, or the like.

The SMF network element may be used to select user plane network elements for the terminal, redirect user plane network elements for the terminal, allocate Internet protocol (IP) addresses to the terminal, establish a bearer (also referred to as a session) between the terminal and the UPF network element, modify and release a session, and control QoS.

The PCF network element is used to provide policies for the AMF network element and the SMF network element, such as QoS policy and slice selection policy.

The AF network element is used to interact with 3GPP core network elements to support the routing of application impact data, access network exposure functions, interact with the PCF network element for policy control, or the like.

DN may be for example IP multi-media service (IMS) network and the Internet, which provide data services for users. There may be multiple application servers (ASs) in the DN, which provide different application services, such as operator services, Internet access, or third-party services. The AS may implement the function of the AF.

The NSSF is used for network slice selection, with the supported functions including: selecting a set of network slice instances serving the UE; determining allowed network slice selection assistance information (NSSAI) and, when necessary, determining the mapping to the subscribed single-network slice selection assistance information (S-NSSAI); determining the configured NSSAI and, when necessary, determining the mapping to the subscribed S-NSSAI; and determining a set of AMFs that may be used for querying the UE, or determining a list of candidate AMFs based on the configuration.

The AUSF is used to receive a request from the AMF to authenticate the terminal, request a key from the UDM, and then forward an issued key to the AMF for authentication processing.

The UDM includes functions such as generation and storage of user contract data, management of authentication data, and supports interaction with external third-party servers.

The NEF is used for capability exposure. That is, based on the NEF, network capabilities may be exported to external networks. External untrusted applications may access internal data of the access core network through the NEF, to ensure security of the network. The NEF may provide external application QoS capability exposure, event subscription, the AF request distribution and other functions.

The NRF is used to register, manage, and detect the status of core network elements, thereby realizing automated management of core network elements. In a case where the core network element is started, it must be registered with the NRF before providing services. Registration information may include, for example, types, addresses, and service lists of the core network element.

In addition, some networks (e.g., 5G networks) have added a network data analytics function (NWDAF) in the core network. Based on the NWDAF, data may be collected from various network elements and network management systems in the core network, and big data statistics, analysis, or intelligent data analysis may be performed, to obtain analysis or prediction data of the network-side, thereby assisting each network element to more effectively control terminal device access based on a data analysis result.

In some communication systems (e.g., 5G systems), the core network element may also be referred to as a network function (NF).

Each network element in FIG. 1 may be a network element in a hardware device, a software function running on a dedicated hardware, or a virtualized function instantiated on a platform (e.g., a cloud platform). It should be noted that the network architecture illustrated in FIG. 1 is only an example of the network elements included in the entire network architecture. The network elements included in the entire network architecture are not limited in the embodiments of the present disclosure.

Those skilled in the art will understand that the network architecture illustrated in FIG. 1 does not constitute a limitation on the network architecture. For, example, in specific implementations, the network architecture may include more or fewer network elements than those illustrated in FIG. 1, or combine certain network elements. It should be understood that in FIG. 1, the AN or the RAN is represented as (R) AN.

### Steering of Roaming (SOR)

The present disclosure relates to SOR (i.e., terminal device bootstrapping in a visited public land mobile network (VPLMN)) in a wireless communication network. In some wireless networks, such as fifth generation (5G) networks, a home operator (e.g., a home public land mobile network (HPLMN)) may direct a terminal device from one network to another network. For example, the terminal device is registered on one public land mobile network (PLMN), and the HPLMN of the terminal device may require the terminal device to register on another PLMN.

The terminal device may perform a PLMN search to find an alternative PLMN. For example, when a terminal device is powered on for the first time, the terminal device may perform an initial PLMN search. After the terminal device is powered on, the terminal device may periodically perform the PLMN search. For example, the periodic PLMN search enables the terminal device to find a PLMN with a higher priority than the current PLMN of the terminal device (the PLMN currently registered by the terminal device is also referred to as the VPLMN or registered PLMN (register PLMN) of the terminal device). For example, the terminal device is registered on a VPLMN (a second network) in addition to its HPLMN (a first network), and the terminal device may periodically search for the HPLMN. When the timer expires, a periodic PLMN search may occur. An example of such a timer is a timer referred to as timer T. The PLMN search occurs only in a case where the terminal device is in an idle mode, idle state, a 5G system mobility management (5GMM) idle mode, or a CM idle state (e.g., a state in which there is no active communication with the network). In response to the terminal device performing a PLMN search/selection in a connected mode, any connectivity will be lost as the radio will have to disconnect from the current PLMN. Therefore, in response to the timer T expiring, the terminal device must wait until the terminal device is in the idle mode before performing the PLMN search.

In some cases, for example, in 4th generation (4G), 3rd generation (3G) or 2nd generation (2G) systems, the HPLMN transmits short messaging (SM) including a security packet once the terminal device has attached to the VPLMN. The security packet includes at least one PLMN identity. The SM is received by a mobile equipment (ME) of the terminal device, and based on indication (e.g., a code point) in the SM, the ME determines that some or all of contents of the SM are used for a universal integrated circuit card (UICC) of the terminal device (e.g., terminal device CC). Then, the UICC receives the SM and decompresses the SM, to determine that it includes the security packet. The content of the security packet updates a preferred operator PLMN list (e.g., the topmost entry) in a universal subscriber identity module (USIM) card, and the UICC transmits a universal subscriber identity module application toolkit refresh command (e.g., a REFRESH command) to the ME. After receiving the refresh command, the ME reads the preferred operator PLMN list from the UICC or the refresh command (if a PLMN list is included) and stores the list in a memory of the ME. Then, the ME performs a PLMN search taking into account the PLMNs in the updated preferred operator PLMN list. Due to security grouping, the updated preferred operator PLMN list may have changed. It will be appreciated that the preferred operator PLMN list is an entry in the USIM application that may only be modified by an entity (e.g., home service provider, HPLMN) that has necessary keys to allow the modification to be performed. However, it may be any application that provides functionality to a terminal device to indicate which network should be selected in a case where the terminal device performs PLMN selection.

In some cases, for example, in 5G networks, the authentication process (which is a part of the registration process) may be used to deliver a list of networks or PLMNs (or a list of preferred PLMN and access technology combinations) to the terminal device.

Relevant information and selection strategies used by terminal devices in a case of selecting a PLMN will be introduced below. Typically, the terminal device may read the following files from a subscriber identity module (SIM) card: HPLMN selector with access technology, user controlled PLMN selector with access technology, forbidden PLMNs, equivalent HPLMN, operator controlled PLMN selector with access technology, or the like.

In some implementations, a non-access stratum (NAS) layer of the terminal device triggers the access layer to read system information of the surrounding cells, and obtains PLMN IDs of the surrounding cells from the system information. The access layer then reports all the PLMN IDs to the NAS layer, and the NAS layer selects a final PLMN from them. In addition, the access layer may further report PLMN signal quality below-110 dB to the NAS layer, that is, “PLMN ID and signal quality”.

In some implementations, the NAS layer follows the following sequence 1 to 5 in a case of selecting a PLMN.

1. The HPLMN (if an equivalent HPLMN (EHPLMN) list does not exist or is empty) or the available EHPLMN with the highest priority (if the EHPLMN list exists).

The HPLMN ID may be obtained from the international mobile subscriber identity (IMSI) of the SIM card. FIG. 2 illustrates an implementation of the IMSI. As illustrated in FIG. 2, the IMSI consists of a maximum of 15 digits, of which the mobile country code (MCC) may occupy 3 digits, the mobile network code (MNC) may occupy 2 or 3 digits, and remaining digits in the IMSI may be used for a mobile subscriber identification number (MSIN). The MCC and the MNC in the IMSI may be used to identify the HPLMN.

In addition, the SIM card may further store a HPLMN selector with access technology. Table 1 shows information included in the HPLMN selector with access technology. As shown in Table 1, the HPLMN selector with access technology may include multiple PLMNs and their corresponding access technologies. The multiple PLMNs are arranged in a priority order. A first PLMN (also referred to as “1st PLMN”) has a higher priority than a second PLMN (also referred to as “2nd PLMN”), and the second PLMN has a higher priority than an nth PLMN (also referred to as “nth PLMN”).

For example, for a mobile 4G card, the terminal device may be configured to select the mobile 4G network and the LTE access technology when selecting a PLMN, and when there is no 4G coverage around, the terminal device may be configured to select a PLMN and the 2G access technology.

It should be noted that, it is understood that the EHPLMN and the HPLMN may provide the same services to the terminal device, and the EHPLMN and the HPLMN have the same functions. In addition, radio access technology (RAT) priorities in Table 1 are also applicable to the EHPLMN.

2. Each PLMN and access technology combination in the user-controlled PLMN selector with access technology in the SIM card (in a priority order).

3. Each PLMN and access technology combination is in the SIM (in a priority order) or in an operation control PLMN selector file with access technology stored in the ME (in a priority order), where the operation control PLMN selector with access technology may be as shown in Table 2 below. In Table 2, each PLMN is followed by an RAT. The higher the ranking of a RAT, the higher the priority.

4. Other PLMN/access technology combinations, receiving high quality signals in a random order.

5. Other PLMN/access technology combinations, arranged in a descending order of signal quality.

TABLE 1

| | | |
|---|---|---|
| Identifier: ‘6F62’ | structure: Transparent | Optional |

| SFI: ‘13’ | |
|---|---|
| File size: 5n | Update activity: low |

| (n ≥ 1) bytes | | | |
|---|---|---|---|
| Access conditions: | | | |
| Read | PIN | | |
| Update | ADM | | |
| Deactivate | ADM | | |
| Activate | ADM | | |
| Bytes | Description | M/O | Length |
| 1 to 3 | 1^{st} PLMN | M | 3 bytes |
| 4 to 5 | 1^{st} PLMN access | M | 2 bytes |
| | technology identifier | | |
| 6 to 8 | 2^{nd} PLMN | O | 3 bytes |
| 9 to 10 | 2^{nd} PLMN access | O | 2 bytes |
| | technology identifier | | |
| . . . | . . . | . . . | . . . |
| (5n − 4) to (5n2) | n^{th} PLMN | O | 3 bytes |
| (5n − 1) to 5n | nth PLMN access | O | 2 bytes |
| | technology identifier | | |

TABLE 2

| | | |
|---|---|---|
| Identifier: ‘6F61’ | Structure: transparent | Optional |

| SFI: ‘11’ | |
|---|---|
| File size: 5n | Update activity: low |

| (n ≥ 8) bytes | | | |
|---|---|---|---|
| Access conditions: | | | |
| Read | PIN | | |
| Update | ADM | | |
| Deactivate | ADM | | |
| Activate | ADM | | |
| Bytes | Description | M/O | Length |
| 1 to 3 | 1st PLMN | M | 3 bytes |
| | (high priority) | | |
| 4 to 5 | 1st PLMN access | M | 2 bytes |
| | technology identifier | | |
| . . . | . . . | . . . | . . . |
| 36 to 38 | 8th PLMN | M | 3 bytes |
| 39 to 40 | 8th PLMN Access | M | 2 bytes |
| | technology identifier | | |
| 41 to 43 | 9th PLMN | O | 3 bytes |
| 44 to 45 | 9th PLMN Access | O | 2 bytes |
| | technology identifier | | |
| . . . | . . . | . . . | . . . |
| (5n − 4) to (5n2) | Nth PLMN | O | 3 bytes |
| | (low priority) | | |
| (5n − 1) to 5n | Nth PLMN access | O | 2 bytes |
| | technology identifier | | |

In some cases, for example, the network slicing technology is introduced in 5G networks. Each network slice may correspond to services of one or more terminal devices. The network slice identifier may be single network slice selection assistance information (S-NSSAI). The S-NSSAI consists of two parts: slice/service type (SST) and slice differentiator (SD). In some implementations, a standard value is set for the SST, and setting of the standard value may be shown in Table 3. As shown in Table 3, in response to the value of the SST being 1, it represents that the slice is suitable for handling 5G enhanced mobile broadband (eMBB). In response to the value of the SST being 2, it represents that the slice is suitable for handling ultra-reliable low latency communications (URLLC). In response to the value of the SST being 3, it represents that the slice is suitable for handling massive IoT. In response to the value of the SST being 4, it represents that the slice is suitable for handling V2X services. In response to the value of the SST being 5, it indicates that the slice is suitable for handling high-performance machine-type communications.

TABLE 3

| | Value | |
|---|---|---|
| | of the | |
| SST | SST | Characteristic |
| eMBB | 1 | Slice being suitable for handling 5G enhanced |
| | | mobile broadband |
| URLLC | 2 | Slice being suitable for handling ultra-reliable |
| | | low latency communications |
| MIoT | 3 | Slice being suitable for handling massive IoT |
| V2X | 4 | Slice being suitable for handling V2X services |
| HMTC | 5 | Slice being suitable for handling |
| | | high-performance machine-type communications |

In some other implementations, the SST and the SD may also be non-standard values. A combination of one or more S-NSSAI is NSSAI.

In some cases, for example, research on a network selection mode based on network slicing was started in 3GPP R18. One possible solution is to reuse a traditional steering of roaming mechanism. The HPLMN configures a PLMN list based on network slicing for the terminal device, and then the terminal device uses this configuration to select a network.

As mentioned above, currently, communication systems support multiple network selection modes. Pieces of information corresponding to different network selection modes and used for selecting network devices are independent of each other. As a result, when a terminal device performs network selection, the terminal device usually first performs network selection based on information corresponding to one network selection mode, and then performs network selection based on information corresponding to another network selection mode. This network selection mode is not flexible enough.

For example, multiple network selection modes include a network selection mode based on a PLMN and a network selection mode based on network slicing. For the network selection mode based on the PLMN, information used for selecting the network may be found in the Table 2. For the network selection mode based on network slicing, information used for selecting the network may include a PLMN list based on network slicing. In this way, after obtaining the above two lists, the terminal device may only start network selection from the PLMN list based on network slicing, and if no suitable PLMN is selected, it will continue to select the network from Table 2. However, the solution of network selection based on two independent tables is not flexible enough.

In addition, a mode of first selecting a network from the PLMN list based on the network slice and then selecting a network from Table 2 may cause a priority of the PLMN selected by the terminal device from the PLMN list of the network slice to be lower than a priority of the PLMN that may be selected in Table 2. In other words, the terminal device selects a PLMN with a low priority for access, which reduces the communication quality of the terminal device.

Therefore, in response to the above problems, embodiments of the present disclosure provide a wireless communication method, in which pieces of information corresponding to different network selection modes and used for network selection are integrated into first information. In this way, the terminal device may perform network selection based on the integrated information, which helps to improve the flexibility of network selection. To facilitate understanding, a wireless communication method in the embodiments of the present disclosure will be introduced below with reference to FIG. 3. FIG. 3 is a schematic diagram of a wireless communication method according to the embodiments of the present disclosure. The method illustrated in FIG. 3 includes step S310.

In step S310, a first network device transmits first information to a terminal device.

In some implementations, the first information is used for selecting a network. In other words, the first information is used for the terminal device to select a network; or, the first information is used for assisting the terminal device in selecting a network.

In some implementations, the first information is associated with a first PLMN and a second PLMN, and a network selection mode supported by the first PLMN is different from a network selection mode supported by the second PLMN. For example, the network selection mode supported by the first PLMN includes a network selection mode based on network slicing. As another example, the network selection mode supported by the second PLMN includes a network selection mode based on a PLMN.

That is, the first information may include information used for selecting a network associated with the network selection mode based on network slicing, and information used for selecting a network associated with the network selection mode based on the PLMN. For example, the first information may include the PLMN list shown in the above Table 2 and a PLMN list that supports network slicing.

As mentioned above, PLMNs may be arranged according to priorities in Table 2. Correspondingly, PLMNs are also arranged according to priorities in the PLMN list that supports network slicing. Correspondingly, in the embodiments of the present disclosure, multiple PLMNs carried in the first information may also be arranged according to a priority order. For example, the priority order of the multiple PLMNs carried in the first information may be a priority order between PLMNs that support network slicing and PLMNs that do not support network slicing. That is, the priority order of PLMNs in the first information may be a priority order of all PLMNs (including the PLMNs that support network slicing and the PLMNs that do not support network slicing).

To facilitate understanding, the first information in the embodiments of the present disclosure will be exemplarily listed below. Referring to the first information shown below, it may be seen that, the first information may include a first PLMN (also referred to as “1st PLMN”), a second PLMN (also referred to as “2nd PLMN”), and a third PLMN (also referred to as “3rd PLMN”). The first PLMN is a PLMN that supports network selection based on network slicing, the second PLMN is a PLMN that does not support network selection based on network slicing, and the third PLMN is a PLMN that supports network selection based on network slicing. Furthermore, in the first information, priorities among the three PLMNs are as follows: the first PLMN has the highest priority, the second PLMN has the second highest priority, and the third PLMN has the lowest priority. That is, the priority of the first PLMN is higher than the priority of the second PLMN, and the priority of the second PLMN is higher than the priority of the third PLMN.

```
  Example 1 of the first information:
    1st PLMN (high priority);
    AT identifier of the 1st PLMN = next generation radio access network (NG-RAN);
    1st PLMN supporting network slicing/NSSAI;
    2nd PLMN;
    AT identifier of 2nd PLMN = (2G, 3G, evolved universal terrestrial radio access
(E-UTRA) or NG-RAN);
    3rd PLMN;
    AT identifier of 3rd PLMN = NG-RAN;
    3rd PLMN supporting network slicing/NSSAI;
    ...
```

With continued reference to Example 1 of the first information, the first information may include an AT identifier associated with each PLMN (as an example of second information mentioned below). For example, the AT identifier associated with the first PLMN indicates that the AT is the NG-RAN. The AT identifier associated with the second PLMN indicates that the AT includes one of the 2G, the 3G, the E-UTRA, and the NG-RAN. The AT identifier associated with the third PLMN indicates that the AT is the NG-RAN.

In addition, for a PLMN indicating network selection based on network slicing, the first information may further indicate network slices supported by the PLMN. With continued reference to Example 1, the first PLMN and the third PLMN are PLMNs that support the network selection mode based on network slicing. For the first PLMN, the first information includes network slices supported by the first PLMN. For the third PLMN, the first information includes network slices supported by the third PLMN.

It should be noted that the above indication of the network slices supported by the PLMN may include network slice identifiers supported by the PLMN. Certainly, in the embodiments of the present disclosure, the network slices supported by the PLMN may also be represented by the NSSAI.

In some implementations, the first information may include second information. The second information is used for determining an AT associated with the first PLMN.

The specific form of the second information will not be limited in the embodiments of the present disclosure. Since the network selection based on network slicing is a technology introduced in the 5G communication protocol, currently only 5G communication systems support the network selection technology based on network slicing. Accordingly, the AT associated with the first PLMN is generally the NG-RAN. Therefore, in some implementations, the second information is used for indicating that the AT associated with the first PLMN includes an NG-RAN. For example, the second information may be an AT identifier of the NG-RAN.

Taking the example of the first information as an example, for the first PLMN, second information of the first PLMN may include that the AT associated with the first PLMN is the AT identifier of the first PLMN in the first information. That is, “AT identifier of 1st PLMN=NG-RAN”. For the third PLMN, second information of the third PLMN may include that the AT associated with the third PLMN is the AT identifier of the third PLMN in the first information. That is, “AT identifier of 3rd PLMN=NG-RAN”.

As mentioned above, currently only 5G communication systems support the network selection technology based on network slicing. Accordingly, the AT associated with the first PLMN is generally the NG-RAN. Therefore, in order to reduce overhead required for transmitting the first information, the first information may not carry the AT of the first PLMN. In this case, the AT of the first PLMN may be defaulted to the NG-RAN. That is, for a PLMN supporting different network selection types, the AT of the PLMN may or may not be carried in the first information. This flexibility may increase complexity of decoding the first information at the receiving end.

For example, in response to the PLMN not supporting the network selection mode based on network slicing, the first information carries the AT of the PLMN. In response to the PLMN supporting the network selection mode based on network slicing, the first information does not carry the AT of the PLMN. In this case, the receiving end cannot determine whether a currently decoded PLMN supports the network selection mode based on network slicing, and therefore cannot determine whether subsequent decoded information is the AT of the PLMN, which makes it more difficult for the receiving end to decode the first information.

Therefore, in order to reduce the complexity of decoding the first information, indication information (as an example of the second information) may be carried in the first information. The indication information is used for indicating whether the first information carries the AT of the first PLMN. In other words, the indication information indicates that the first information does not carry the AT of the first PLMN. Or, the indication information may be used for indicating whether the AT of the first PLMN is a default AT (e.g., the NG-RAN).

In some implementations, the above indication information may be 1 bit, which helps reduce the overhead required to transmit the first information. For example, in response to a value of the bit being “1”, it indicates that the first information carries the AT of the first PLMN. In response to the value of the bit being “0”, it indicates that the first information does not carry the AT of the first PLMN. For another example, in response to the value of the bit being “1”, it indicates that the first information does not carry the AT of the first PLMN. In response to the value of the bit being “0”, it indicates that the first information carries the AT of the first PLMN. Certainly, in the embodiments of the present disclosure, the above indication information may also occupy n bits, where n is a positive integer greater than 1.

In other words, for example, in response to the value of the bit being “1”, it indicates that the AT of the first PLMN is not the default AT. In response to the value of the bit being “0”, it indicates that the AT of the first PLMN is the default AT. For another example, in response to the value of the bit being “1”, it indicates that the AT of the first PLMN is the default AT. In response to the value of the bit being “0”, it indicates that the AT of the first PLMN is not the default AT.

To facilitate understanding, first information in another embodiment of the present disclosure will be introduced below. Referring to Example 2 of the first information, the first information may include a first PLMN (also referred to as “1st PLMN”). The first PLMN supports a network selection mode based on network slicing, and the first information carries indication information 1 of the first PLMN. The indication information 1 indicates that an AT of the first PLMN is not carried in the first information. That is, the indication information 1 may be 1 bit, and the value of the bit is “1”, which indicates that the first information does not carry the AT of the first PLMN.

It should be noted that, in the embodiments of the present disclosure, the indication information 1 may further be used for indicating that an AT associated with the corresponding PLMN is a default access technology, i.e., an NG-RAN. For example, the indication information 1 of the first PLMN is used for indicating that the AT of the first PLMN is the NG-RAN. For another example, indication information 1 of the third PLMN is used for indicating that an AT of the third PLMN is the NG-RAN.

```
Example 2 of the first information:
  1st PLMN (high priority);
  indication information 1 of the 1st PLMN;
  1st PLMN supporting network slicing/NSSAI;
  2nd PLMN;
  AT identifier of the 2nd PLMN = (2G, 3G, E-UTRA or NG-RAN);
  3rd PLMN;
  indication information 1 of the 3rd PLMN;
  3rd PLMN supporting network slicing/NSSAI;
  ...
```

With continued reference to Example 2 of the first information, in some implementations, for a PLMN indicating network selection based on network slicing, the first information may further indicate network slices supported by the PLMN. With continued reference to Example 2, the first PLMN and the third PLMN are PLMNs that support a network selection mode based on network slicing. For the first PLMN, the first information includes network slices supported by the first PLMN. For the third PLMN, the first information includes network slices supported by the third PLMN.

It should be noted that the above indication of the network slices supported by the PLMN may include network slice identifiers supported by the PLMN. Certainly, in the embodiments of the present disclosure, the network slices supported by the above PLMN may also be represented by the NSSAI.

In other implementations, multiple PLMNs carried in the first information may also be arranged according to a priority order. For example, with continued reference to Example 2 of the first information, the first information indicates that the priority of the first PLMN has the highest priority, the priority of the second PLMN has the second highest priority, and the priority of the third PLMN has the lowest priority. That is, the priority of the first PLMN is higher than the priority of the second PLMN, and the priority of the second PLMN is higher than the priority of the third PLMN.

Based on the above introduction of Example 1 and Example 2 regarding the first information, it may be seen that, in some implementations, the first information may carry network slice information associated with the first PLMN. The network slice information associated with the first PLMN may be, for example, the NSSAI. Alternatively, the network slice information associated with the first PLMN may be the network slice identifiers supported by the first PLMN. Certainly, in the embodiments of the present disclosure, the first information may further carry other information. Taking the first PLMN in Example 1 of the first information as an example, the first information may include a first PLMN identifier, the priority of the first PLMN, the AT of the first PLMN, and the NSSAI of the first PLMN.

In other embodiments, information associated with the first PLMN in the first information may only include a first PLMN identifier, priority information of the first PLMN, and network slice information associated with the first PLMN. That is, the information associated with the first PLMN in the first information does not include the AT of the first PLMN. For example, referring to Example 2 of the first information, the first information may include the first PLMN identifier, the priority of the first PLMN, the indication information 1 of the first PLMN and the NSSAI of the first PLMN. In this case, the first information does not include the AT of the first PLMN. Accordingly, the AT of the first PLMN in the first information may be the default AT.

It should be noted that the AT of the first PLMN is introduced above by taking the NG-RAN as an example, which will not be limited in the embodiments of the present disclosure. The AT of the first PLMN may also be an AT supported by a future communication system. For example, the AT of the first PLMN may also be an AT supported by a 6G communication system.

A carrying manner of the first information will not be limited in detail in the embodiments of the present disclosure. In some implementations, the first information may be carried in a registration accept message. In some other implementations, the first information may be carried in a registration reject message. In some yet other implementations, the first information may be carried in a downlink NAS transport message.

In addition, the first network device will not be limited in the embodiments of the present disclosure. For example, the first network device may be an AMF. Alternatively, the first network device may be other network device having similar or identical functions to the AMF.

In some implementations, the first PLMN associated with the first information is associated with network slice(s) requested by the terminal device. In other words, the first PLMN associated with the first information may be determined based on the network slice(s) requested by the terminal device. For example, the network slices supported by the first PLMN associated with the first information may include the network slice(s) requested by the terminal device. For another example, the network slice(s) requested by the terminal device may include the network slice(s) supported by the first PLMN associated with the first information.

A network slice requested by the terminal device may be transmitted from the terminal device to the first network device through third information. That is, the above method further includes: transmitting, by the terminal device, the third information to the first network device, where the third information is used for indicating the network slice requested by the terminal device. Accordingly, the above step S310 further includes: receiving, by the terminal device, the first information transmitted by the first network device, where the first PLMN associated with the first information is associated with a network slice requested by the terminal device.

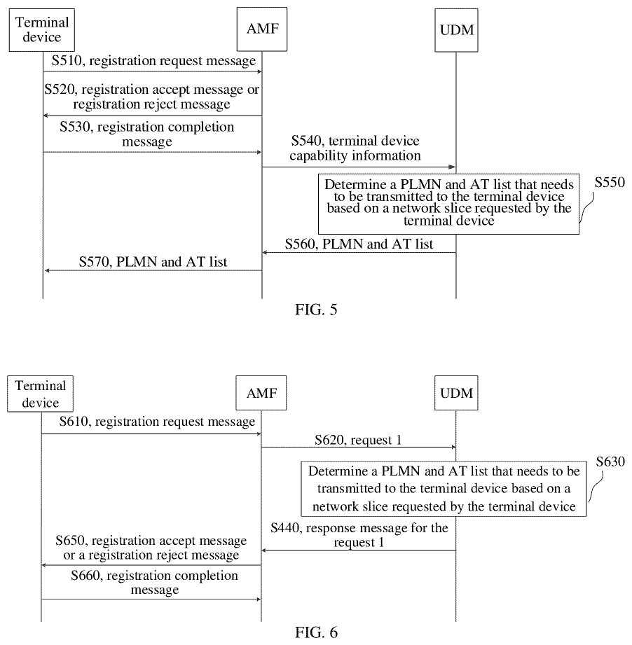

A carrying manner of the third information will not be limited in the embodiments of the present disclosure. For example, the third information may be carried in a registration request. The registration request is used for requesting registration of the terminal device with the first network device, which will be introduced below with reference to FIG. 4 and FIG. 5. For the sake of brevity, no further details will be repeated here.

In some scenarios, in a case where the first network device transmits the first information to the terminal device, but the terminal device and/or the second network device does not support the network selection mode based on network slicing, the transmission of the first information is unnecessary, which may result in a waste of transmission resources.

Therefore, to address the above problem, the first information may be transmitted in a case where the terminal device and the second network device both support the network selection mode based on network slicing. That is, the above step S310 may include: in response to the terminal device and the second network device both supporting the network selection mode based on network slicing, receiving, by the terminal device, the first information transmitted by the second network device through the first network device.

The second network device will not be limited in detail in the embodiments of the present disclosure. For example, the second network device may be a UDM. Certainly, in the embodiments of the present disclosure, the second network device may also be other network device in future communication systems having similar or identical functions to the UDM.

In some implementations, the first information may be transmitted by the second network device to the first network device. That is, before the above step S310, the above method further includes: transmitting, by the second network device, the first information to the first network device.

The carrying manner of the first information will not be limited in the embodiments of the present disclosure. In some implementations, the first information may be carried in subscription data transmitted by the second network device to the first network device, where the subscription data may be, for example, network slice selection subscription data. Certainly, in the embodiments of the present disclosure, the first information may be carried in other signaling, which will be introduced below with reference to FIG. 4 to FIG. 7. For the sake of brevity, no further details will be repeated here.

As mentioned above, in a case where the terminal device supports the network selection mode based on network slicing, the first network device may transmit the first information to the terminal device. In the embodiments of the present disclosure, there is no limitation on how the first network device determines that the terminal device supports the network selection based on network slicing. In some implementations, the terminal device may transmit terminal capability information to the first network device, to indicate whether the terminal device supports the network selection mode based on network slicing. That is, the above method further includes: transmitting, by the terminal device, terminal capability information to the first network device, where the terminal capability information is used for indicating whether the terminal device supports the network selection mode based on network slicing. A carrying manner of the terminal capability information will not be limited in the embodiments of the present disclosure. In some implementations, the terminal capability information may be carried in a registration request message. In some other implementations, the terminal capability information may be carried in a registration completion message of a registration request, where the registration request is used for requesting registration of the terminal device to the AMF. That is, the first network device may be the AMF.

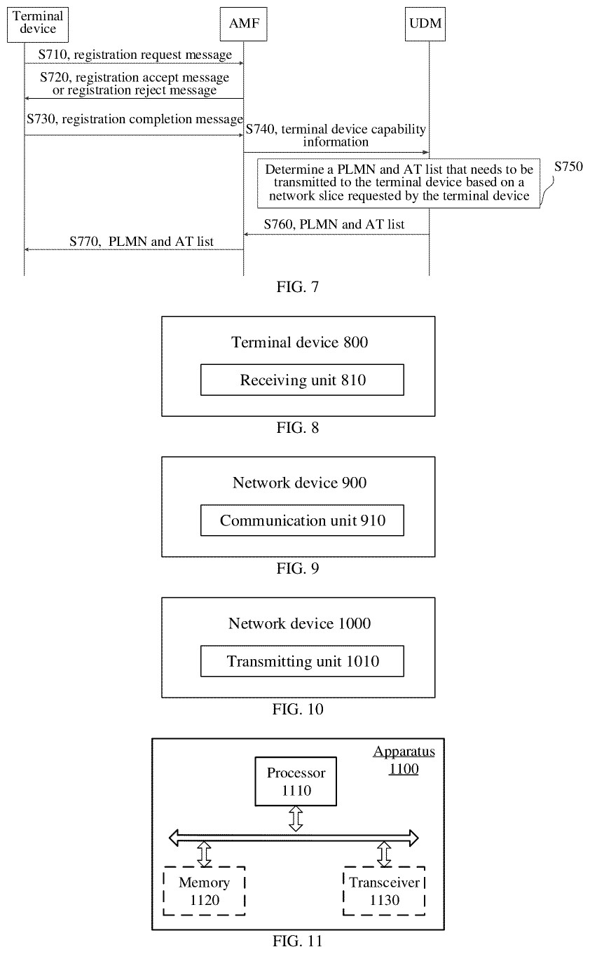

To facilitate understanding, the wireless communication methods in the embodiments of the present disclosure will be introduced below with reference to FIG. 4 to FIG. 7. FIG. 4 and FIG. 6 are introduced by taking Example 1 of the first information as an example. FIG. 5 and FIG. 7 are introduced by taking Example 2 of the first information as an example.

FIG. 4 is a schematic flowchart of a wireless communication method according to another embodiment of the present disclosure. The method illustrated in FIG. 4 includes steps S410 to S460.

In step S410, the terminal device transmits a registration request message to the AMF.

In some implementations, the registration request message includes terminal device capability information and/or the network slice requested by the terminal device. Here, the terminal device capability information is used for indicating whether the terminal device supports the network selection mode based on network slicing. The network slice requested by the terminal device may include the requested network slice selection assistance information (NSSAI).

In step S420, the AMF transmits a request 1 to the UDM.

In some implementations, the request 1 is used for requesting subscription data of the network slice from the UDM. The request 1 may include the terminal device capability information and the network slice requested by the terminal device.

In step S430, in response to the UDM supporting the network selection mode based on network slicing, the UDM determines a PLMN and AT list that needs to be transmitted to the terminal device based on the network slice requested by the terminal device.

In some implementations, the UDM needs to consider the network slice requested and/or contracted by the terminal device, such that the network slice supported by the PLMN included in a final PLMN and AT list may only include the network slice requested or contracted by the terminal device.

In addition, the PLMN and AT list includes PLMNs that support the network selection mode based on network slicing (e.g., the 1st PLMN and the 3rd PLMN in Example 1 of the first information), the corresponding ATs and the supported network slices. Certainly, the PLMN and AT list further includes unsupported PLMNs and corresponding ATs (e.g., the 2nd PLMN in Example 1 of the first information), and the multiple PLMNs are sorted according to priorities. That is, the priority of the 1st PLMN is higher than the priority of the 2nd PLMN, and the priority of the 2nd PLMN is higher than the priority of the 3rd PLMN.

In step S440, the UDM transmits a response message to the AMF for the request 1.

In some implementations, the response message for the request 1 includes the PLMN and AT list.

In step S450, the AMF transmits a registration accept message or a registration reject message to the terminal device.

In some implementations, the registration accept response or the registration reject response may include the PLMN and AT list.

In step S460, in response to the terminal device receiving the registration accept message, the terminal device transmits a registration completion message to the AMF.

FIG. 5 is a schematic flowchart of a wireless communication method according to another embodiment of the present disclosure. The method illustrated in FIG. 5 includes steps S510 to S570.

In step S510, the terminal device transmits a registration request message to the AMF.

In step S520, the AMF transmits a registration accept message or a registration reject message to the terminal device.

In step S530, in response to the terminal device receiving the registration accept message, the terminal device transmits a registration completion message to the AMF.

In some implementations, the registration completion message may include the terminal device capability information, and/or the network slice requested by the terminal device. The terminal device capability information is used for indicating whether the terminal device supports the network selection mode based on network slicing, and the network slice requested by the terminal device may include the requested NSSAI.

In step S540, the AMF forwards the terminal device capability information to the UDM.

In some implementations, in response to the AMF receiving the network slice requested by the terminal device, the AMF forwards the network slice requested by the terminal device to the UDM.

In step S550, in response to the UDM supporting the network selection mode based on network slicing, the UDM determines the PLMN and AT list that needs to be transmitted to the terminal device based on the network slice requested by the terminal device.

In some implementations, the UDM needs to consider the network slice requested and/or contracted by the terminal device, such that the network slice supported by the PLMN included in a final PLMN and AT list may only include the network slice requested or contracted by the terminal device.

In addition, the PLMN and AT list includes PLMNs that support the network selection mode based on network slicing (e.g., the 1st PLMN and 3rd PLMN in Example 1 of the first information), the corresponding ATs and the supported network slices. Certainly, the PLMN and AT list further includes unsupported PLMNs and corresponding ATs (e.g., the 2nd PLMN in Example 1 of the first information), and the multiple PLMNs are sorted according to priorities. That is, the priority of the 1st PLMN is higher than the priority of the 2nd PLMN, and the priority of the 2nd PLMN is higher than the priority of the 3rd PLMN.

In step S560, the UDM transmits the PLMN and AT list to the AMF.

In step S570, the AMF transmits a downlink (DL) NAS transport message to the terminal device, where the message carries the PLMN and AT list.

FIG. 6 is a schematic flowchart of a wireless communication method according to an embodiment of the present disclosure. The method illustrated in FIG. 6 includes steps S610 to S660.

In step S610, the terminal device transmits a registration request message to the AMF.

In some implementations, the registration request message includes terminal device capability information and/or the network slice requested by the terminal device. The terminal device capability information is used for indicating whether the terminal device supports the network selection mode based on network slicing, and the network slice requested by the terminal device may include the requested NSSAI.

In step S620, the AMF transmits a request 1 to the UDM.

In some implementations, the request 1 is used for requesting subscription data of the network slice from the UDM. The request 1 may include the terminal device capability information and the network slice requested by the terminal device.

In step S630, in response to the UDM supporting the network selection mode based on network slicing, the UDM determines a PLMN and AT list that needs to be transmitted to the terminal device based on the network slice requested by the terminal device.

In some implementations, the UDM needs to consider the network slice requested and/or contracted by the terminal device, such that the network slice supported by the PLMN included in a final PLMN and AT list may only include the network slice requested or contracted by the terminal device.

In addition, the PLMN and AT list includes PLMNs that support the network selection based on network slicing (e.g., the 1st PLMN and 3rd PLMN in Example 2 of the first information), the corresponding indication information 1 and the supported network slices. The indication information 1 indicates that ATs corresponding to the 1st PLMN and the 3rd PLMN are not carried in the first information. Certainly, the PLMN and AT list further includes unsupported PLMNs and corresponding ATs (e.g., the 2nd PLMN in Example 2 of the first information), and the multiple PLMNs are sorted according to priorities. That is, the priority of the 1st PLMN is higher than the priority of the 2nd PLMN, and the priority of the 2nd PLMN is higher than the priority of the 3rd PLMN.

In step S640, the UDM transmits a response message to the AMF for the request 1.

In some implementations, the response message for the request 1 includes the PLMN and AT list.

In step S650, the AMF transmits a registration accept message or a registration reject message to the terminal device.

In some implementations, the registration accept response or the registration reject response may include the PLMN and AT list.

In step S660, in response to the terminal device receiving the registration accept message, the terminal device transmits a registration completion message to the AMF.

FIG. 7 is a schematic flowchart of a wireless communication method according to another embodiment of the present disclosure. The method illustrated in FIG. 7 includes steps S710 to S770.

In step S710, the terminal device transmits the registration request message to the AMF.

In step S720, the AMF transmits the registration accept message or the registration reject message to the terminal device.

In step S730, in response to the terminal device receiving the registration accept message, the terminal device transmits a registration completion message to the AMF.

In some implementations, the registration completion message may include the terminal device capability information, and/or the network slice requested by the terminal device. The terminal device capability information is used for indicating whether the terminal device supports the network selection mode based on network slicing, and the network slice requested by the terminal device may include the requested NSSAI.

In step S740, the AMF forwards the terminal device capability information to the UDM.

In some implementations, in response to the AMF receiving the network slice requested by the terminal device, the AMF forwards the network slice requested by the terminal device to the UDM.

In step S750, in response to the UDM supporting the network selection mode based on network slicing, the UDM determines the PLMN and AT list that needs to be transmitted to the terminal device based on the network slice requested by the terminal device.

In some implementations, the UDM needs to consider the network slice requested and/or contracted by the terminal device, such that the network slice supported by the PLMN included in a final PLMN and AT list may only include the network slice requested or contracted by the terminal device.

In addition, the PLMN and AT list includes PLMNs that support the network selection based on network slicing (e.g., the 1st PLMN and 3rd PLMN in Example 1 of the first information), the corresponding indication information 1 and the supported network slices. The indication information 1 indicates that the ATs corresponding to the 1st PLMN and the 3rd PLMN are not carried in the first information. Certainly, the PLMN and AT list further includes unsupported PLMNs and corresponding ATs (e.g., the 2nd PLMN in Example 1 of the first information). The multiple PLMNs are sorted according to priorities. That is, the priority of the 1st PLMN is higher than the priority of the 2nd PLMN, and the priority of the 2nd PLMN is higher than the priority of the 3rd PLMN.

In step S760, the UDM transmits the PLMN and AT list to the AMF.

In step S770, the AMF transmits a downlink (DL) NAS transport message to the terminal device, where the message carries the PLMN and AT list.

The method embodiments of the present disclosure are described in detail above with reference to FIGS. 1 to 7, and apparatus embodiments of the present disclosure are described in detail below with reference to FIGS. 8 to 11. It should be understood that the description of the method embodiments corresponds to the description of the apparatus embodiments. Therefore, parts that are not described in detail may refer to the above method embodiments.

FIG. 8 is a schematic diagram of a terminal device according to an embodiment of the present disclosure. A terminal device 800 illustrated in FIG. 8 includes a receiving unit 810.

The receiving unit 810 is configured to receive first information transmitted by a first network device and used for selecting a network. The first information is associated with a first PLMN and a second PLMN, and a network selection mode supported by the first PLMN is different from a network selection mode supported by the second PLMN.

In a possible implementation, the network selection mode supported by the first PLMN includes a network selection mode based on network slicing; and/or the network selection mode supported by the second PLMN includes a network selection mode based on a PLMN.

In a possible implementation, the first information includes second information, and the second information is used for determining an AT associated with the first PLMN.

In a possible implementation, the second information is used for indicating whether the first information carries the AT associated with the first PLMN; or the second information is used for indicating that the AT associated with the first PLMN includes a network access technology based on an NG-RAN.

In a possible implementation, the first information carries network slice information associated with the first PLMN. Or, in response to the second information being used for indicating whether the first information carries the AT associated with the first PLMN, information associated with the first PLMN in the first information only includes a first PLMN identifier, the second information, priority information of the first PLMN and network slice information supported by the first PLMN.

In a possible implementation, the terminal device further includes a transmitting unit. The transmitting unit is configured to transmit third information to the first network device, where the third information is used for indicating a network slice requested by the terminal device. The receiving unit is configured to receive the first information transmitted by the first network device, where the first PLMN associated with the first information is associated with the network slice requested by the terminal device.

In a possible implementation, the terminal device and a second network device both support the network selection mode based on the network slicing, and the receiving unit is configured to receive the first information transmitted by the second network device through the first network device.

In a possible implementation, the first information is carried in a registration accept message or a registration reject message; or the first information is carried in a downlink NAS transport message.

FIG. 9 is a schematic diagram of a network device according to an embodiment of the present disclosure. The network device 900 illustrated in FIG. 9 is a first network device, and the network device 900 includes a communication unit 910.

The communication unit 910 is configured to receive or transmit first information used for selecting a network, where the first information is associated with a first PLMN and a second PLMN, and a network selection mode supported by the first PLMN is different from a network selection mode supported by the second PLMN.

In a possible implementation, the network selection mode supported by the first PLMN includes a network selection mode based on network slicing; and/or the network selection mode supported by the second PLMN includes a network selection mode based on a PLMN.

In a possible implementation, the first information includes second information, and the second information is used for determining an AT associated with the first PLMN.

In a possible implementation, the second information is used for indicating that the AT associated with the first PLMN is a default access mode; or the second information is used for indicating that the AT associated with the first PLMN includes a network access technology based on an NG-RAN.

In a possible implementation, the first information carries network slice information associated with the first PLMN. Or, in response to the second information being used for indicating whether the first information carries the AT associated with the first PLMN, information associated with the first PLMN in the first information only includes a first PLMN identifier, the second information, priority information of the first PLMN and network slice information supported by the first PLMN.

In a possible implementation, the communication unit is configured to: receive third information transmitted by a terminal device, where the third information is used for indicating a network slice requested by the terminal device; and transmit the first information to the terminal device, where the first PLMN associated with the first information is associated with the network slice requested by the terminal device.

In a possible implementation, a second network device and the terminal device both support the network selection mode based on the network slicing. The communication unit is configured to receive the first information transmitted by the second network device; and transmit the first information to the terminal device.

In a possible implementation, in response to the first network device transmitting the first information, the first information is carried in a registration accept message or a registration reject message, or the first information is carried in a downlink NAS transport message. Or, in response to the first network device receiving the first information, the first information is carried in network slice subscription data.

FIG. 10 is a schematic diagram of a network device according to another embodiment of the present disclosure. The network device 1000 illustrated in FIG. 10 is a second network device. The network device 1000 includes a transmitting unit 1010.

The transmitting unit 1010 is configured to transmit first information used for selecting a network to a first network device, where the first information is associated with a first PLMN and a second PLMN, and a network selection mode supported by the first PLMN is different from a network selection mode supported by the second PLMN.

In a possible implementation, the network selection mode supported by the first PLMN includes a network selection mode based on network slicing; and/or the network selection mode supported by the second PLMN includes a network selection mode based on a PLMN.

In a possible implementation, the first information includes second information, and the second information is used for determining an AT associated with the first PLMN.

In a possible implementation, the second information is used for indicating that the AT associated with the first PLMN is a default access mode; or the second information is used for indicating that the AT associated with the first PLMN includes a network access technology based on a NG-RAN.

In a possible implementation, the first information carries network slice information associated with the first PLMN. Or, in response to the second information being used for indicating whether the first information carries the AT associated with the first PLMN, information associated with the first PLMN in the first information only includes the first PLMN identifier, the second information, priority information of the first PLMN and network slice information supported by the first PLMN.

In a possible implementation, the second network device and a terminal device both support the network selection mode based on the network slicing, and the transmitting unit is configured to transmit the first information to the terminal device through the first network device.

In a possible implementation, the first information is carried in network slice subscription data.

In an optional embodiment, the receiving unit 810 may be a transceiver 1130. The terminal device 800 may further include a processor 1110 and a memory 1120, as specifically illustrated in FIG. 11.

In an optional embodiment, the communication unit 910 may be a transceiver 1130. The network device 900 may further include a processor 1110 and a memory 1120, as specifically illustrated in FIG. 11.

In an optional embodiment, the transmitting unit 1010 may be a transceiver 1130. The network device 1000 may further include a transceiver 1130 and a memory 1120, as specifically illustrated in FIG. 11.

FIG. 11 is a schematic structural diagram of a communication apparatus according to an embodiment of the present disclosure. The dashed lines in FIG. 11 indicate that the unit or module is optional. The apparatus 1100 may be configured to implement the methods described in the above method embodiments. The apparatus 1100 may be a chip, a terminal device, or a network device.

The apparatus 1100 may include one or more processors 1110. The processor 1110 may support the apparatus 1100 to implement the methods described in the above method embodiments. The processor 1110 may be a general purpose processor or a special purpose processor. For example, the processor may be a central processing unit (CPU). Alternatively, the processor may be another general purpose processor, a digital signal processors (DSP), an application specific integrated circuit (ASIC), a field programmable gate array (FPGA) or another programmable logic device, a discrete gate or a transistor logic device, a discrete hardware component, or the like. The general purpose processor may be a microprocessor, or the processor may be any conventional processor or the like.

The apparatus 1100 may further include one or more memories 1120. The memory 1120 stores thereon a program, and the program may be performed by the processor 1110 to enable the processor 1110 to perform the methods described in the above method embodiments. The memory 1120 may be independent of the processor 1110 or may be integrated into the processor 1110.

The apparatus 1100 may further include a transceiver 1130. The processor 1110 may communicate with other devices or chips through the transceiver 1130. For example, the processor 1110 may transmit data and receive data with other devices or chips through the transceiver 1130.

The embodiments of the present disclosure further provide a non-transitory computer-readable storage medium for storing a program. The non-transitory computer-readable storage medium may be applied in the terminal or the network device provided in the embodiments of the present disclosure. The program enables a computer to perform the method performed by the terminal or the network device in various embodiments of the present disclosure.

The embodiments of the present disclosure further provide a computer program product. The computer program product includes a program. This computer program product may be applied in the terminal or the network device provided in the embodiments of the present disclosure. The program enables a computer to perform the method performed by the terminal or the network device in various embodiments of the present disclosure.

The embodiments of the present disclosure further provide a computer program. The computer program may be applied in the terminal or the network device provided in the embodiments of the present disclosure. The computer program enables a computer to perform the method performed by the terminal or the network device in various embodiments of the present disclosure.

It should be understood that the terms “system” and “network” may be used interchangeably in the present disclosure. In addition, the terms used in the present disclosure are only used for explaining the specific embodiments of the present disclosure and are not intended to limit the present disclosure. The terms “first”, “second”, “third”, and “fourth” in the specification, claims and drawings of the present disclosure are used for distinguishing different objects rather than for describing a specific order. In addition, the terms “include”, “comprises”, and “has” and any variations thereof, are intended to cover a non-exclusive inclusion.

In the embodiments of the present disclosure, the “indication” mentioned may mean a direct indication, an indirect indication, or an indication of an association relationship. For example, A indicates B, which may mean that A directly indicates B, for example, B may be obtained through A; or it may mean that A indirectly indicates B, for example, A indicates C, and B may be obtained through C; or it may mean that there is an association relationship between A and B.

In the embodiments of the present disclosure, “B corresponding to A” means that B is associated with A, and B may be determined based on A. However, it should further be understood that determining B based on A does not mean determining B based solely on A. B may also be determined based on A and/or other information.

In the embodiments of the present disclosure, the term “corresponding” may indicate a direct or indirect correspondence between the two, or an association relationship between the two, or a relationship between indicating and being indicated, configuring and being configured, or the like.

In the embodiments of the present disclosure, “pre-defined” or “pre-configured” may be implemented by pre-saving corresponding codes, tables or other methods capable of being used for indicating relevant information in a device (e.g., including a terminal device and a network device), with its specific implementation will not be limited in the present disclosure. For example, pre-defined may refer to that defined in a protocol.

In the embodiments of the present disclosure, the “protocol” may refer to a standard protocol in the communications field, for example, it may include an LTE protocol, an NR protocol, and related protocols used in future communication systems, which will not be limited in the present disclosure.

In the embodiments of the present disclosure, the term “and/or” is only a description of an association relationship of associated objects, and indicates that there may be three kinds of relationships. For example, A and/or B may represent three cases: A exists alone, both A and B exist, and B exists alone. In addition, the character “/” herein generally indicates that the associated objects before and after this character are in an “or” relationship.

In various embodiments of the present disclosure, the magnitude of the serial numbers of the above processes does not indicate an execution order. The execution order of each process should be determined by its function and internal logic, and should not constitute any limitation on the implementation process of the embodiments of the present disclosure.

In the several embodiments provided by the present disclosure, it should be understood that the disclosed system, apparatuses/devices and methods may be implemented in other manners. For example, the apparatus/device embodiments described above are only schematic. For example, the division of the units is only a division of logical functions. There may be other division manners in the actual implementation. For example, a plurality of units or components may be combined or integrated into another system, or some features may be ignored or not implemented. In addition, the mutual coupling, direct coupling or communication connection shown or discussed may be indirect coupling or communication connection through some interfaces, apparatuses/devices, or units, which may be in electrical, mechanical or other forms.

The units described as separation components may or may not be physically separated, and the components illustrated as units may or may not be physical units. That is, they may be located at one place, or may be distributed onto a plurality of network units. Some or all of the units may be selected according to actual requirements to implement the purpose of the solution of the embodiments.

In addition, various functional units in various embodiments of the present disclosure may be integrated into one processing unit, or various units may exist physically alone, or two or more units may be integrated into one unit.

In the above embodiments, all or part of the above embodiments may be implemented by software, hardware, firmware or any combination thereof. When implemented using software, all or part of the above embodiments may be implemented in a form of a computer program product. The computer program product includes one or more computer instructions. When the computer program instructions are loaded and executed on a computer, the process or the function described in the embodiments of the present disclosure is generated in all or part. The computer may be a general purpose computer, a special purpose computer, a computer network, or another programmable apparatus. The computer instructions may be stored in a non-transitory computer-readable storage medium, or transmitted from one non-transitory computer-readable storage medium to another non-transitory computer-readable storage medium. For example, the computer instructions may be transmitted from a website, computer, server, or data center to another website, computer, server, or data center through wired manner (e.g., coaxial cable, optical fiber, or digital subscriber line (DSL)) or wireless manner (e.g., infrared, radio, or microwave). The non-transitory computer-readable storage medium may be any available medium that is capable of being read by the computer or a data storage device containing one or more available media integrated together, such as a server or a data center. The available medium may be a magnetic medium (e.g., a floppy disk, a hard disk, or a magnetic tape), an optical medium (e.g., a digital video disc (DVD)), or a semiconductor medium (e.g., a solid state disk (SSD)).

The foregoing descriptions are merely specific implementations of the present disclosure, but the protection scope of the present disclosure is not limited thereto. Any skilled person in the art could readily conceive of changes or replacements within the technical scope of the present disclosure, which shall be all included in the protection scope of the present disclosure. Therefore, the protection scope of the present disclosure shall be subject to the protection scope of claims.

What is claimed is:

1. A wireless communication method, comprising:
receiving, by a terminal device, first information transmitted by a first network device and used for selecting a network, wherein the first information is associated with a first public land mobile network (PLMN) and a second PLMN, and a network selection mode supported by the first PLMN is different from a network selection mode supported by the second PLMN.

2. The method according to claim 1, wherein the network selection mode supported by the first PLMN comprises a network selection mode based on network slicing; and/or
the network selection mode supported by the second PLMN comprises a network selection mode based on a PLMN.

3. The method according to claim 1, wherein the first information comprises second information, and the second information is used for determining an access technology (AT) associated with the first PLMN.

4. The method according to claim 3, wherein the second information is used for indicating whether the first information carries the AT associated with the first PLMN; or
the second information is used for indicating that the AT associated with the first PLMN comprises a network access technology based on a next generation radio access network (NG-RAN).

5. The method according to claim 3, wherein the first information carries network slice information associated with the first PLMN; or
in response to the second information being used for indicating whether the first information carries the AT associated with the first PLMN, information associated with the first PLMN in the first information only comprises a first PLMN identifier, the second information, priority information of the first PLMN and network slice information supported by the first PLMN.

6. The method according to claim 1, further comprising:
transmitting, by the terminal device, third information to the first network device, wherein the third information is used for indicating a network slice requested by the terminal device; and
receiving, by the terminal device, the first information transmitted by the first network device and used for selecting the network comprises:
receiving, by the terminal device, the first information transmitted by the first network device, wherein the first PLMN associated with the first information is associated with the network slice requested by the terminal device.

7. The method according to claim 2, wherein the terminal device and a second network device both support the network selection mode based on the network slicing, and receiving, by the terminal device, the first information transmitted by the first network device and used for selecting the network comprises:
receiving, by the terminal device, the first information transmitted by the second network device through the first network device.

8. The method according to claim 1, wherein the first information is carried in a registration accept message or a registration reject message; or
the first information is carried in a downlink non-access stratum (NAS) transport message.

9. A terminal device, comprising: a transceiver, a memory and a processor, wherein the memory is configured to store a computer program, and the computer program, when executed by the processor, enables the terminal device to perform:
receiving first information transmitted by a first network device and used for selecting a network, wherein the first information is associated with a first public land mobile network (PLMN) and a second PLMN, and a network selection mode supported by the first PLMN is different from a network selection mode supported by the second PLMN.

10. The terminal according to claim 9, wherein the network selection mode supported by the first PLMN comprises a network selection mode based on network slicing; and/or
the network selection mode supported by the second PLMN comprises a network selection mode based on a PLMN.

11. The terminal according to claim 9, wherein the first information comprises second information, and the second information is used for determining an access technology (AT) associated with the first PLMN.

12. The terminal according to claim 11, wherein the second information is used for indicating whether the first information carries the AT associated with the first PLMN; or
the second information is used for indicating that the AT associated with the first PLMN comprises a network access technology based on a next generation radio access network (NG-RAN).

13. The terminal according to claim 11, wherein the first information carries network slice information associated with the first PLMN; or
in response to the second information being used for indicating whether the first information carries the AT associated with the first PLMN, information associated with the first PLMN in the first information only comprises a first PLMN identifier, the second information, priority information of the first PLMN and network slice information supported by the first PLMN.

14. The terminal according to claim 9, wherein the computer program, when executed by the processor, enables the terminal device further to perform:
transmitting third information to the first network device, wherein the third information is used for indicating a network slice requested by the terminal device; and
receiving the first information transmitted by the first network device and used for selecting the network comprises:
receiving the first information transmitted by the first network device, wherein the first PLMN associated with the first information is associated with the network slice requested by the terminal device.

15. A first network device, comprising: a transceiver, a memory and a processor, wherein the memory is configured to store a computer program, and the computer program, when executed by the processor, enables the first network device to perform:
receiving or transmitting first information used for selecting a network, wherein the first information is associated with a first public land mobile network (PLMN) and a second PLMN, and a network selection mode supported by the first PLMN is different from a network selection mode supported by the second PLMN.

16. The first network device according to claim 15, wherein the network selection mode supported by the first PLMN comprises a network selection mode based on network slicing; and/or
the network selection mode supported by the second PLMN comprises a network selection mode based on a PLMN.

17. The first network device according to claim 15, wherein the first information comprises second information, and the second information is used for determining an access technology (AT) associated with the first PLMN.

18. The first network device according to claim 17, wherein the second information is used for indicating that the AT associated with the first PLMN is a default access mode; or
the second information is used for indicating that the AT associated with the first PLMN comprises a network access technology based on a next generation radio access network (NG-RAN).

19. The first network device according to claim 17, wherein the first information carries network slice information associated with the first PLMN; or
in response to the second information being used for indicating whether the first information carries the AT associated with the first PLMN, information associated with the first PLMN in the first information only comprises a first PLMN identifier, the second information, priority information of the first PLMN and network slice information supported by the first PLMN.

20. The first network device according to claim 16, wherein the computer program, when executed by the processor, enables the first network device further to perform:
receiving third information transmitted by a terminal device, wherein the third information is used for indicating a network slice requested by the terminal device; and
receiving or transmitting the first information used for selecting the network comprises:
transmitting the first information to the terminal device, wherein the first PLMN associated with the first information is associated with the network slice requested by the terminal device.
